(19) United States
(12) Patent Application Publication
(10) Pub. No.: US 2008/0257452 A1
(43) Pub. Date: Oct. 23, 2008

(54) Guiding apparatus for tenon fabrication machines

(76) Inventor: Jack Yang, Taichung County (TW)

Correspondence Address: Joe McKinney Muncy, PO Box 1364, Fairfax, VA, 22038-1364, US

(21) Appl. No.: 11/785,518

(22) Filed: Apr. 18, 2007

(51) Int. Cl. B27F 1/00

(52) U.S. Cl. 144/205

(57) ABSTRACT

The invention having a chassis includes a transverse guiding plate located at the front side of the chassis and two sliding rods running through a sliding member which is run through by two rods from the front side to the rear side. A moving cap that the two rods run through is provided to cover the sliding member having a slant plate at the front side. An anchor slat which is run through by a moving bar having a rear end movable along the jagged teeth of the guiding plate at the bottom is provided in front of the moving cap to be pivotally coupled with a handle bar having a rear end coupled with rollers which press the slant plate. By depressing the handle bar downwards, the moving cap can be moved forwards to make the moving bar to escape the jagged teeth of the guiding plate to be repositioned.

### FIELD OF THE INVENTION

The present invention relates to a woodwork tenon fabrication machine and particularly to a guiding apparatus for tenon fabrication machines to provide movement guidance at a lower manual loading force.

### BACKGROUND OF THE INVENTION

A conventional woodwork tenon fabrication machine as shown in FIG. 1 mainly includes a chassis I which has a driving motor 2 located inside. The driving motor 2 has a spindle directing upwards to hold a cutter which can be moved forwards rearwards, leftwards and rightwards to perform cutting operation on a wooden work piece and form a row of tenon ditch (or latch tenons) in an equally spaced fashion. There is a guiding plate 3 with jagged teeth formed thereon located at the front side of the chassis 1. Referring to FIG. 2, the guiding plate 3 aims to be leaned over by a rear end of a moving bar 4 which is movable transversely. The moving bar 4 has a front end pivotally coupled on a vertical front wall of a moving cap 5. The moving cap 5 also has a rear wall. The front and rear walls of the moving cap 5 is run through by two parallel rods 6 which also run through a sliding member 7. The sliding member 7 has the bottom run through by two transverse sliding rods 8 at the front side. The moving cap 5 has a rear end fastened to the driving motor 2 which is movable with the moving cap 5. The cutter at the upper side of the driving motor 2 can be moved synchronously. There is also a gear rack 9 at the upper side of the chassis 1 corresponding to the guiding plate 3. The gear rack 9 has a top portion fastened to a wooden work piece. The cutter has the top end corresponding to a front edge of the work piece and movable along the gear rack 9 to cut the work piece to form a jagged tenon ditch or latch tenons.

Due to the position of the moving bar 4 has to be matched with the work piece, before cutting the moving cap 5 has to be moved forwards and anchored to allow the moving bar 4 below to escape the indented teeth of the guiding plate 3 so that it can be moved leftwards or rightwards to match the work piece. As the moving cap 5 also carries the driving motor 2 at the rear end, moving the moving cap 5 by hands takes a lot of efforts. There is still room for improvement.

### SUMMARY OF THE INVENTION

The primary object of the present invention is to provide a guiding apparatus for tenon fabrication machines. The guiding apparatus is located at the front side of a chassis. The chassis includes a transverse guiding plate located at the front side of the chassis and two sliding rods. The two sliding rods run through a sliding member. The sliding member has the top portion run through by two rods from the front side to the rear side. The two rods have a rear end fastened to a slat. The slat has a lower side fastened to a motor. A moving cap is provided to cover the sliding member. The two rods further run through a front wall and a rear wall of the moving cap in a forward and rearward manner. The sliding member has a slant plate at the front side inclining from the front side to the rear side. An anchor slat is provided at the front side of the moving cap.

The anchor slat is pivotally coupled with a handle bar in the middle. The handle bar has a rear end hinged with a pair of rollers. The rollers press the slant plate. The anchor plate has the bottom run through by a moving bar. The moving bar has a rear end movable on the jagged teeth of the guiding plate.

Thus by depressing the front end of the handle bar, the rollers at the rear end can be moved upwards along the slant plate.

Thereby the moving cap can be moved forwards to drive the moving bar to escape the indented teeth of the guiding plate and be moved leftwards and rightwards at a new position to match the position of the work piece. Such a structure also can save human effort.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional woodwork tenon fabrication machine.

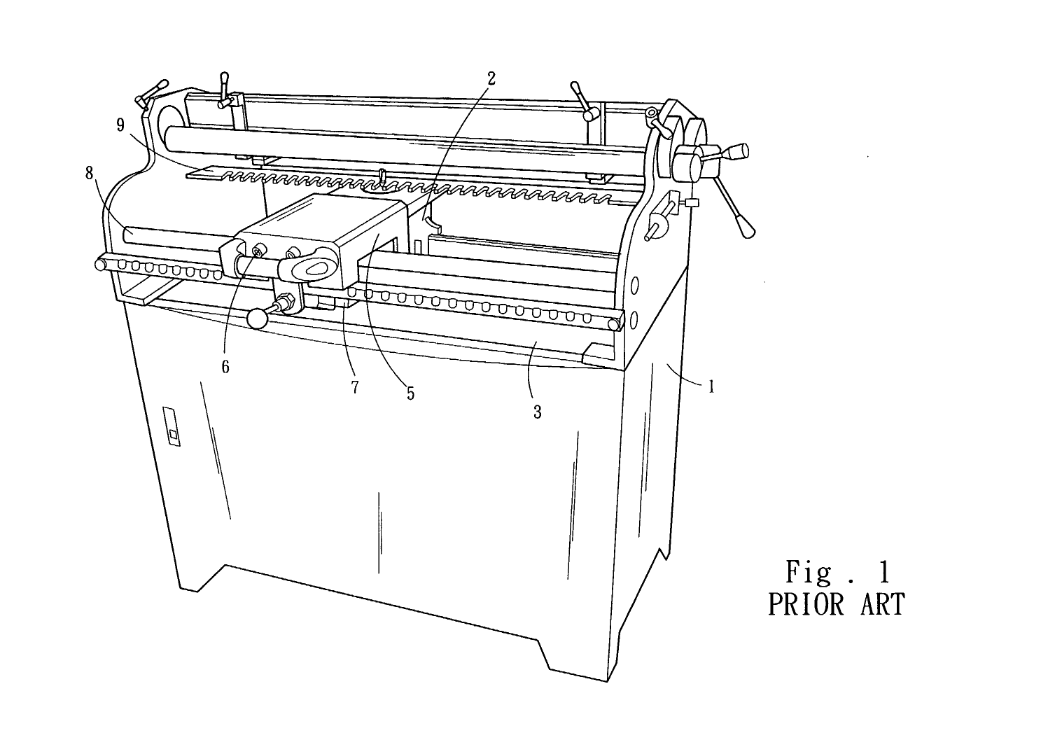

FIG. 2 is a fragmentary perspective view of a conventional woodwork tenon fabrication machine.

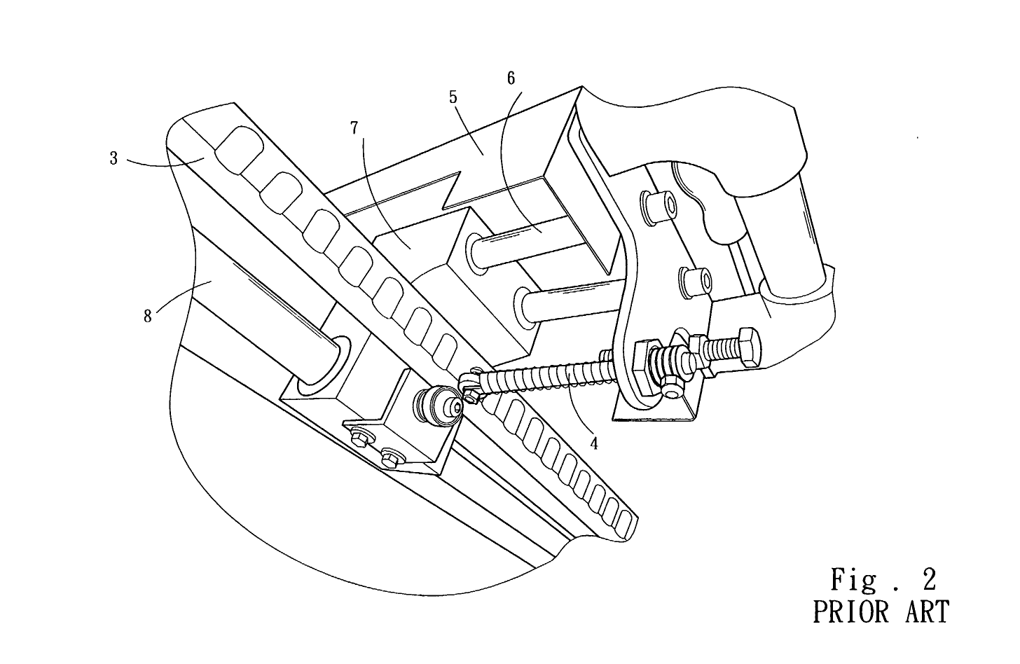

FIG. 3 is a fragmentary exploded view of an embodiment of the invention.

FIG. 4 is a perspective view of an embodiment of the invention.

FIG. 5A is a fragmentary sectional view of an embodiment of the invention.

FIG. 5B is a schematic view according to FIG. 5A in an operating condition.

### DETAILED DESCRIPTION OF THE PREFERRED EMBODIMENT

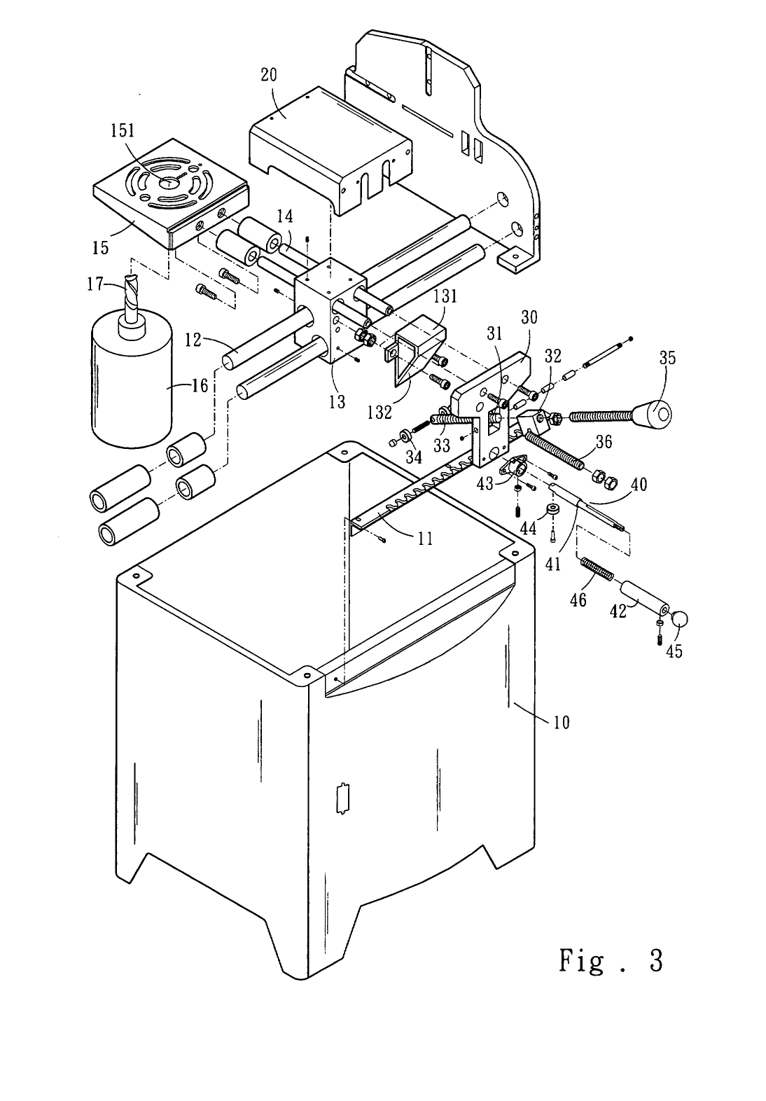

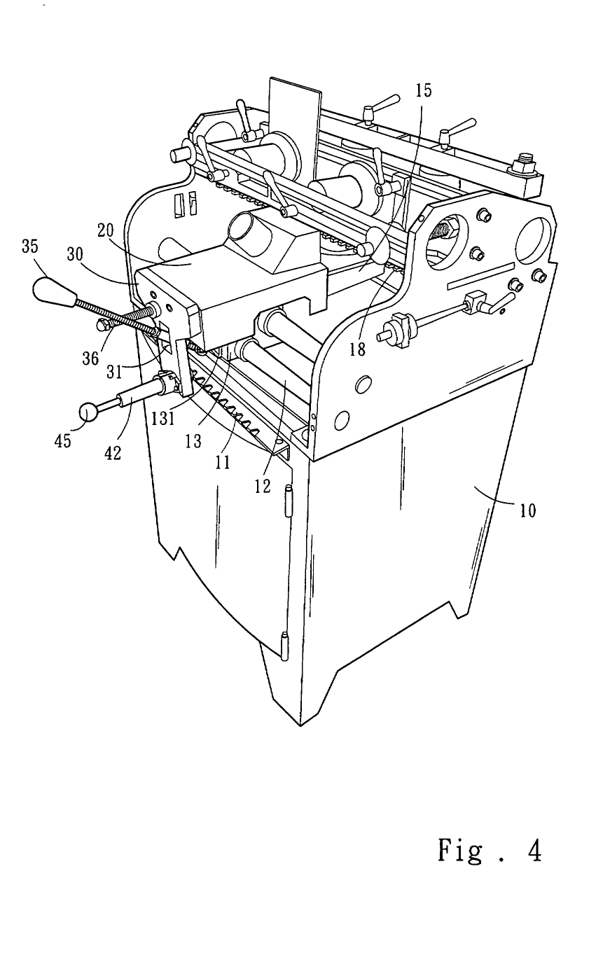

Please refer to FIGS. 3 and 4, the guiding apparatus for tenon fabrication machines according to the invention is located at a front side of a chassis 10 of a tenon fabrication machine. The chassis 10 includes a guiding plate 11 located transversely at the front side that has jagged teeth formed thereon and two sliding rods 12. The two sliding rods 12 run through a sliding member 13. The sliding member 13 has a top portion run through by two rods 14 from the front side to the rear side. The two rods 14 have a rear end fastened to a slat 15.

The slat 15 has the bottom fastened to a motor 16. The motor 16 has a spindle extended upwards from the top to hold a cutter 17. The cutter 17 runs through an aperture 151 formed in the middle of the slat 15 to cut a wooden work piece. There is a transverse gear rack 18 located above the chassis 10 that has jagged teeth formed thereon. The work piece is located above the gear rack 18. The sliding member 13 has a front wall fastened to a wedge-shaped member 131. The wedge-shaped member 131 has a front wall inclined from the upper side to the rear lower side to form a slant plate 132.

A moving cap 20 formed like a box is provided with an opening directing downwards to cover the top of the sliding member 13. The two rods 14 further run through a front wall and a rear wall of the moving cap 20 in the forward and rearward direction.

An anchor slat 30 formed substantially in a T-shape is provided and located at the front wall of the moving cap 20, and has the left side and right side of the upper portion fastened to the front end of the two rods 14. The anchor slat 30 further has a square opening 31 in the middle to be coupled with a lump-shaped coupling member 32. Referring to FIG. SA, a handle bar 33 is provided with a front section and a rear section fastened respectively to the coupling member 32. The coupling member 32 has a middle portion pivotally coupled with the opening 31 to become turnable. The handle bar 33 has a rear end hinged on a pair of rollers 34, and a handle 35 at the front side to be grasped by a user's hand. The rollers 34 press the slant plate 132 of the wedge-shaped member 131 and are movable upwards thereon.

A pulling bar 36 is provided that has a rear end fastened to the anchor slat 30 and a front end to be pulled by the user's hand.

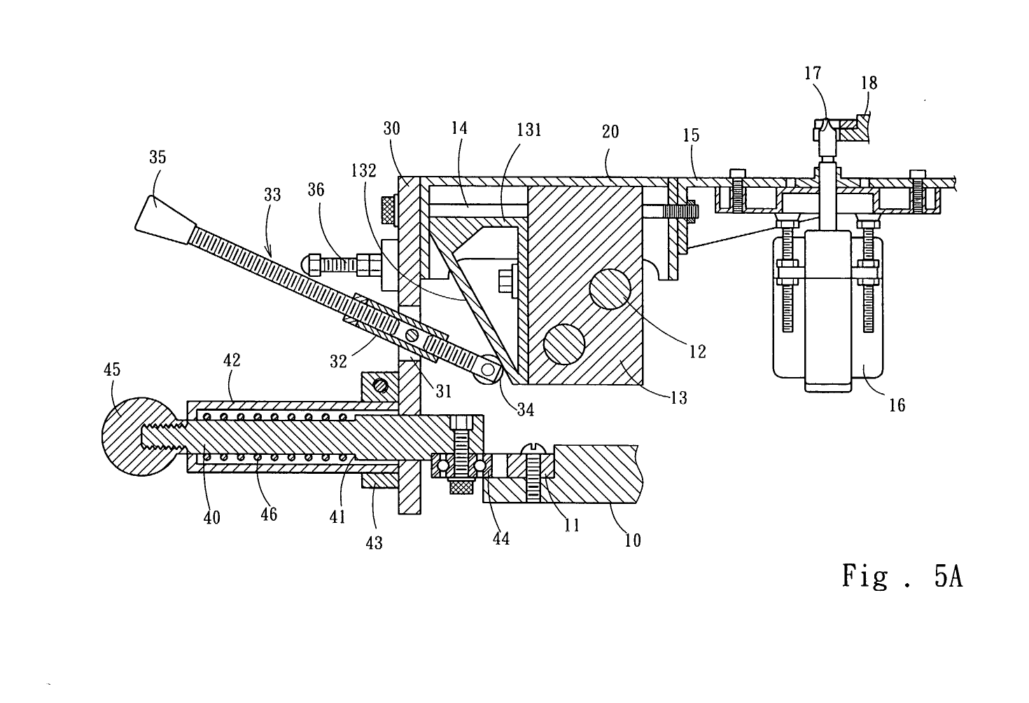

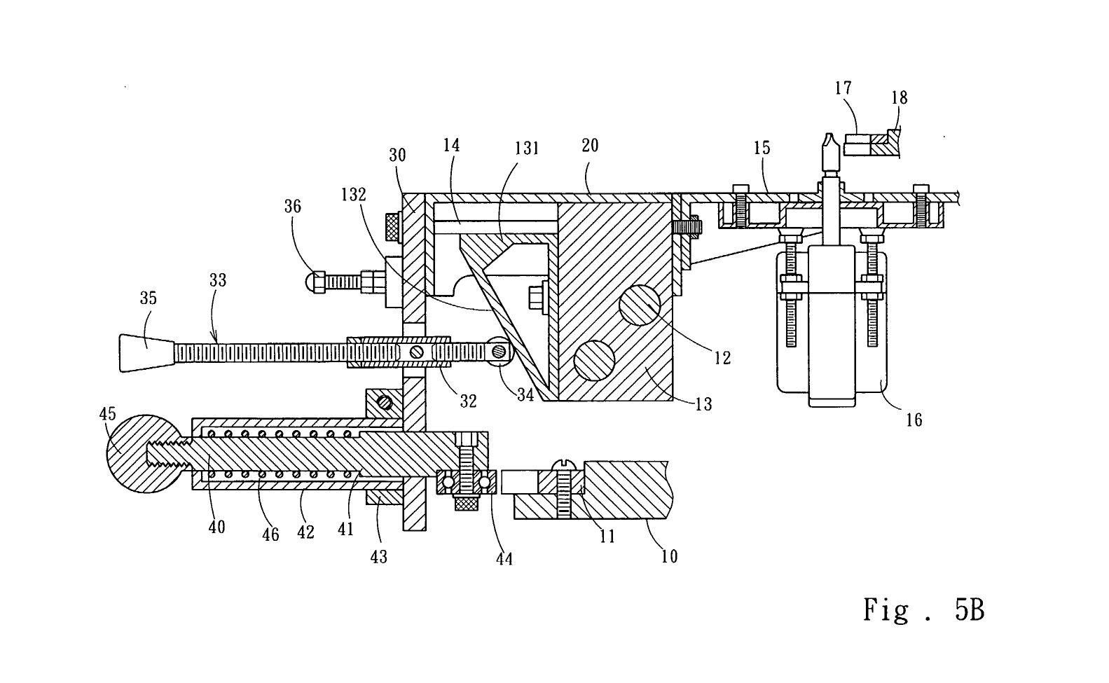

There is a moving bar 40 which has a rear end transversely run through the anchor slat 30. Also referring to FIG. 5A, the moving bar 40 has a rear section formed at a diameter greater than a front section thereof, and a middle section to form a bucking rim 41. It is encased by an outer tube 42 and fastened by a contracting sleeve 43 to the anchor slat 30 at a rear side of the outer tube 42. The moving bar 40 has a rear end formed a longitudinal and circular guiding portion 44 positioned horizontally, and a front end fastened to a bar head 45. The guiding portion 44 is movable along the jagged teeth at the front edge of the guiding plate 11. An extensible elastic element 46 (such as a spring) is provided to run through the front section of the moving bar 40 and located in the outer tube 42. The elastic element 46 has a rear end pressing the bucking rim 41 of the moving bar 40 and a front end pressed by the front wall of the outer tube 42.

By means of the aforesaid construction, the wooden work piece is positioned in advance above the gear rack 18 of the chassis 10. The guiding portion 44 at the rear side of the moving bar 40 is corresponding to the cutting position of the work piece. During operation the moving cap 20 is moved to make the guiding portion 44 at the rear end of the moving bar 40 to escape the indented teeth of the guiding plate 11 and be moved to a desired position to be anchored anew. During operation the handle 35 of the handle bar 33 is moved downwards by a user's hand. The rollers 34 at the rear side of the handle bar 33 are moved upwards along the slant plate 132 of the wedge-shaped plate 132. The inclined angle of the slant plate 132 allows the moving cap 20 to be pushed forwards.

Referring to FIG. 5B, the anchor slat 30 in front of the moving cap 20 also is moved forwards. The moving bar 40 below the anchor slat 30 also is moved forwards at the same time. The guiding portion 44 at the rear end escapes the indented teeth of the guiding plate 11 and can be moved leftwards or rightwards. When the handle bar 33 is released, the rollers 34 at the rear end of the handle bar 33 can be moved downwards along the slant plate 132 to allow the guiding portion 44 to be latched in the indented teeth of the guiding plate 11 again.

Thus the moving bar 40 can be pulled and moved upwards through the rollers 34 rolling on the slant plate 132 to save user's effort.

During the cutter 17 performs cutting operation, the sliding member 13 can be moved from the left side to the right side to drive the moving cap 20 to move synchronously, and the cutter 17 at the top of the motor 16 at the rear side of the moving cap 20 is corresponding to the work piece to perform fabrication of the tenons. The guiding portion 44 of the moving bar 40 in front of the moving cap 20 can be moved forwards, rearwards, leftwards or rightwards along the jagged teeth of the guiding plate 11, and the cutter 17 also is moved forwards, rearwards, leftwards or rightwards simultaneously to cut a tenon ditch of jagged teeth at the front edge of the work piece along the jagged teeth of the guiding plate 11.

Prototypes of the invention have been made according to the description and drawings previously discussed. Test results confirmed that the object and function of the invention can be met satisfactorily.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A guiding apparatus for a tenon fabrication machine located at a front side of a chassis of the tenon fabrication machine, comprising:
a guiding plate located transversely in front of the chassis that has jagged teeth and two sliding rods which run through a sliding member, the sliding member having a top portion run through by two rods from a front side to a rear side, the two rods having a rear end fastened to a slat, the slat having the bottom fastened to a motor, the motor having a spindle extended upwards from the top to hold a cutter, the cutter running through an aperture formed in the middle of the slat to cut a work piece located above the chassis, the work piece being positioned above a gear rack located in front of the chassis, the sliding member having a slant plate at a front wall thereof;
a moving cap covering the sliding member and having a front wall and a rear wall run through by the two rods from the front side to the rear side;
an anchor slat which is located in front of the moving cap and has a middle portion pivotally coupled with a handle bar, the handle bar having a rear end hinged with a pair of rollers which press the slant plate and a front end depressible downwards by a user's hand; and
a moving bar which transversely runs through the anchor slat at a lower side and has a rear end movable along the jagged teeth of the guiding plate.

2. The guiding apparatus of claim 1, wherein the anchor slat has a square opening in the middle to be pivotally coupled with a lump-shaped coupling member, the handle bar having a front section and a rear section fastened to the coupling member, and a handle at a front side to be grasped by the user's hand.

3. The guiding apparatus of claim 1, wherein the moving bar has a rear section formed at a diameter greater than a front section to form a bucking rim and is encased by an outer tube, the front section being coupled with an extensible elastic element which has a rear end pressing the bucking rim and a front end pressing a front wall of the outer tube, the moving bar having a front side fastened to a bar head, the outer tube being coupled with a contracting sleeve to be fastened to the anchor slat, the moving bar having a rear end coupled with a longitudinal and circular guiding portion in a horizontal fashion.

4. The guiding apparatus of claim 1, wherein the anchor slat has a front side fastened to a pulling bar.

5. The guiding apparatus of claim 1, wherein the front wall of the sliding member is fastened to a wedge-shaped member which has a front wall inclining from a upper side to a lower side to form the slant plate.
